(19) United States
(12) Patent Application Publication
(10) Pub. No.: US 2006/0116271 A1
(43) Pub. Date: Jun. 1, 2006

(54) Continuous blood separator

(76) Inventors: Mehdi Hatamian, Coto De Caza, CA (US); Mehrtosh Ghalebi, Rancho Santa Margarita, CA (US); Matin Ebneshahrashoob, Huntington Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/184,543

(22) Filed: Jul. 18, 2005

Related U.S. Application Data
(60) Provisional application No. 60/588,553, filed on Jul. 16, 2004.

(30) Foreign Application Priority Data
Jul. 18, 2005 (WO) PCT/US05/25258

(51) Int. Cl. B04B 7/08

(52) U.S. Cl. 494/37; 210/512.1; 210/787; 494/42; 494/66

(57) ABSTRACT

The disclosed inventions relate to systems and methods for separating fluids into constituent fluid components. For example, apheresis is a process by which blood is drawn from a patient, the blood is separated and/or modified, and at least a portion of the blood is returned to the patient. In some embodiments, fluid separation can be accomplished in a continuous, in-line flow. For example, the fluid can separate in a direction transverse to the general direction of flow through the system. Baffles or spiral-shaped separation chambers can be used in a rotating fluid separation device.

### RELATED APPLICATIONS

This application claims priority to pending U.S. Provisional Patent Application No. 60/588,553, filed Jul. 16, 2004, entitled CONTINUOUS BLOOD SEPARATOR, the entirety of which is hereby incorporated by reference and made part of this specification.

### BACKGROUND OF THE INVENTIONS

1. Field of the Inventions

The disclosed inventions relate to systems and methods for separating fluids into constituent fluid components. For example, apheresis is a process by which blood is drawn from a patient, the blood is separated and/or modified, and at least a portion of the blood is returned to the patient.

2. Description of the Related Art

Existing apheresis processes can have negative effects on patients. For example, many apheresis and similar processes draw blood in sudden, relatively large doses from the patient, causing trauma, nausea, or other harmful side effects. These large draws are often repeated in order to obtain enough blood for the desired medical test or therapy, but the effect of repeated heavy draws of blood from a patient can be harmful. Furthermore, existing methods can be inefficient and can cause inconvenient delays in the time it takes for blood to separate or travel through an apheresis system. Moreover, many existing apheresis systems are expensive and unwieldy. Therefore, a need exists for improved systems and methods for separating fluids. In particular, a need exists for improved systems and methods for efficiently separating blood constituents in a continuous flow apheresis device, and for apheresis devices that are less expensive to manufacture and operate.

### SUMMARY OF THE INVENTIONS

In some embodiments, a fluid separation system has a fluid source comprising fluid with at least two fluid subcomponents. The fluid separation system can have a fluid pump and a rotating device. Furthermore, the fluid separation system can have a separation chamber having an axis of rotation through which bulk fluid moves in a direction transverse to the axis of rotation. In some embodiments, the fluid separation chamber is in a spiral configuration with a rectangular cross-section. In some embodiments, the fluid separation chamber comprises baffles and fluid extraction channels. In some embodiments, the fluid extraction channels are parallel to the axis of rotation.

An apparatus for fluid separation can have a fluid separation chamber. The fluid separation chamber can have a first portion having a first width and a first fluid extraction point located apart from a second portion. The fluid separation chamber can also have a third portion having a third width and a third fluid extraction point located apart from the second portion. Moreover, the fluid separation chamber can have a second portion between the first and third portions with a second width that is narrower than the first and third widths and a second fluid extraction point that is located apart from the first and third portions. The apparatus for fluid separation can further comprise three fluid extraction pathways in fluid communication with the first, second, and third fluid extraction points.

A method for designing a continuous fluid separation system can include: choosing a shape of a separation chamber; choosing extraction points for fluid components; and choosing a flow rate for fluid components.

A continuous centrifuge system can comprise a drum and a coil. The coil can have a coil inlet, a coil outlet, and a blood flow path defined therebetween, the blood flow path comprising a first segment that comprises at least one mixed-fluid chamber and a second segment that comprises at least two constituent chambers, the coil being coupled with a surface of the drum. The continuous centrifuge system can further include an inlet connector configured to transfer whole blood from a source conduit to the inlet of the coil. Moreover, the continuous centrifuge system can have an outlet connector configured to transfer blood constituents from each of the constituent chambers of the second segment of the blood flow path to corresponding outlet conduits, and the system can operate such that rotation of the drum causes whole blood transferred to the coil inlet to be substantially separated into at least two blood constituents at the coil outlet.

A continuous blood separator can comprise a coil having an inlet, an outlet, and a blood flow path defined therebetween, the blood flow path comprising a first segment having at least one whole blood passage and a second segment having at least two blood constituent passages, the inlet configured to receive whole blood and to direct the whole blood to the first segment of the blood flow path, the outlet configured to receive at least one blood constituent from each of the blood constituent passages. The first segment can be dimensioned such that the whole blood received at the inlet of the coil is substantially separated into blood constituents therein. In some embodiments, the blood separator can have a length defined between the inlet and the second segment whereby the whole blood received at the inlet of the coil is substantially separated into blood constituents.

In some embodiments, a method of continuously separating fluid into constituents can include the following aspects: providing a fluid mixture; rotating the fluid mixture in a first separation chamber to separate the fluid into constituents inside the first separation chamber, each constituent having a boundary region where that fluid constituent borders on another fluid constituent; and separately siphoning the fluid constituents from the separation chamber through openings formed apart from the boundary regions. In some embodiments, the method can further comprise rotating the siphoned fluid constituents in a second separation chamber and separately siphoning the fluid constituents from the second separation chamber through openings formed apart from the boundary regions in the second separation chamber.

A fluid separation device can have a first portion having an input tube and baffles. The device can have a second portion having an outer sleeve, a hub, and output tubes. Furthermore, the device can include a separation region formed between the first and second portions comprising successive inner and outer chambers that are in fluid communication with each other and with the input tube and the output tubes.

A continuous flow centrifugation system can include a source module comprising mixed fluid. The system can also include a flow module and a rotating separation module comprising inner chambers with a smaller radius, and outer chambers with a larger radius. The system can also have extraction channels in fluid communication with the inner and outer chambers. In some embodiments, the system can further comprise fluid pathways connecting the extraction channels to storage modules. In some embodiments, the system can further comprise fluid pathways connecting the extraction channels to the source module. In some embodiments, the source module can comprise a human. In some embodiments, the flow module comprises a peristaltic pump. In some embodiments, the separation module comprises baffles.

### BRIEF DESCRIPTION OF THE DRAWINGS

The invention is described in further detail in the Detailed Description of the Preferred Embodiments and the appended drawings, which illustrate some examples but do not to limit the invention, and wherein:

FIG. 1 is an elevational perspective view of a test tube with fluid (e.g., blood) that has been separated into fluid components (e.g., by centrifugation).

FIG. 2 is a schematic diagram of a system for separating fluid.

FIG. 3 schematically shows a coil-shaped separation chamber for in-line fluid separation.

FIG. 4 shows a side view of a continuous centrifuge system having a coil assembly and spiral flow characteristics.

FIG. 5 shows a perspective view of the coil assembly portion depicted in FIG. 4.

FIG. 6 shows a cut-away perspective view of the coil assembly portion depicted in FIG. 4 and FIG. 5.

FIG. 7 is a schematic diagram of a fluid separation process.

FIG. 8 shows a perspective view of a test tube-like chamber with a narrow middle portion.

FIG. 9 is a schematic diagram of a separation design process.

FIG. 10 is a schematic diagram of a purification/separation process.

FIG. 11 schematically depicts a separation chamber having two rings.

FIG. 12 shows a cross-sectional side view of a baffle embodiment of a fluid separation device.

FIG. 13 is an elevational perspective view of a baffle portion of the baffle embodiment of FIG. 12.

FIG. 14 is an elevational perspective view of a sleeve portion of the baffle embodiment of FIG. 12.

FIG. 15 is a schematic diagram of a system for separating fluid in a continuous flow device.

FIG. 16 shows an elevational view of an embodiment of a testing system for a fluid separation system.

### DETAILED DESCRIPTION OF THE PREFERRED EMBODIMENTS

Continuous flow fluid separation is useful in many chemical, medical, research, and industrial contexts. Many times fluids mix with other fluids and it is desired to reverse that process and separate those fluids, sorting the fluid subcomponents according to density and/or molecular weight. In some cases, particles are present in solution and these particles need to be precipitated out of or removed from the solution.

Blood apheresis is one common medical use of continuous fluid separation. Apheresis has many clinical uses, including multiple therapies that involve removing blood from a patient's body, separating the blood into components, altering one of the components, and putting some mixture or selection from the removed and/or altered fluid back in to the patient's body. Some exemplary therapeutic apheresis procedures include: therapeutic plasma exchange (TPE), a procedure by which cell-free plasma is removed and replaced with colloid/saline solution, (e.g. 5% serum albumin, FFP, or cryosupernatant); cytoreduction, a process by which platelets and white blood cells are removed; photopheresis, a procedure by which mononuclear cells collected by therapeutic apheresis are exposed to ultraviolet-A light and psoralen, and reinfused into the patient; and selective adsorption, a process by which plasma is adsorbed on a column (e.g., protein A affinity and selective low-density lipoprotein (LDL) adsorption columns) and returned to the patient.

TPE can help remove an abnormal circulating plasma factor or a physiologic factor that is present in excess amounts in the body. Factors that can be removed are: specific antibodies (e.g., Goodpasture's or Myasthenia); immunoglobulins (e.g., to treat Hyperviscosity syndrome); immune complexes (e.g., SLE); and protein bound toxins or drugs (e.g., “death cap” mushroom toxin). One plasma factor that can be replaced, if deficient, is von Willebrand factor-cleaving protease (TTP). TPE can also have non-specific immunomodulatory effects, such as removal of inflammatory mediators, improvement in RES function, of effects on immune regulation.

Furthermore, efficient apheresis can be used to provide a more efficient and less unconfortable experience for those who wish to donate blood, in addition to helping make donated blood more safe for clinical use. For example, if only a portion of the blood is in demand, that portion can be separated and the remaining portions can flow back in to the donor. Many other applications exist. For example, apheresis can be used to test athletes for doping violations without excess blood removal, and those who have had a drug overdose can be treated by detoxifying their blood with apheresis techniques.

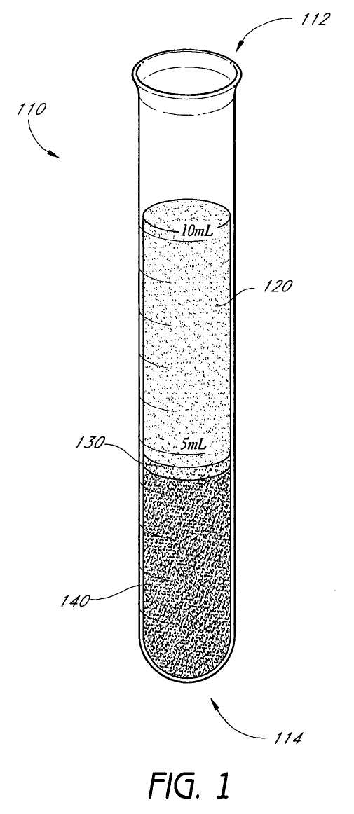

FIG. 1 illustrates a test tube 110 that contains fluid components that have been separated out into three different strata, each stratum containing components of like density. The strata can be the subcomponents of blood that are visible when a test tube with of human blood is centrifuged. In the case of separated blood, the upper layer 120 comprises plasma, which is approximately 55% of total blood volume. In most cases, plasma is generally 91% water, 7% blood proteins (e.g., fibrinogen, albumin, and globulin), 2% nutrients (e.g., amino acids, sugars, and lipids), and also contains hormones (e.g., erythropoietin, insulin, etc.) and electrolytes (e.g., sodium, potassium, calcium, etc.). In the case of blood, the middle layer 130 (or “buffy coat”) and the lower layer 140 (or red blood cells (RBC's)) are referred to as the cellular components, and comprise approximately 45% of total blood volume. The middle layer 130 or buffy coat contains white blood cells (approximately 7000-9000 per mm³ of blood) and platelets (approximately 250,000 per mm³ of blood). There are about 5,000,000 RBCs per mm³ of blood.

Separation of fluid constituents can be accomplished by placing one or multiple test tubes in a centrifuge. The centrifuge is balanced using a counterweight or by inserting test tubes in positions across from each other, and then the test tube is spun rapidly such that the portion of the test tube closest to the opening 112 spins in a circle of smaller radius and the portion of the test tube closest to the end 114 spins in a circle of larger radius. The two portions (the opening 112 and the end 114), and indeed the entire length of the test tube 110, generally spins in a plane about an axis transverse to the elongate axis of the test tube 110.

While the centrifuge (not shown) spins the test tube 110, multidirectional fluid flow can occur. This fluid flow is useful and can allow stratification of the various blood constituents. For example, blood constituents that are more dense and have a higher specific gravity can move under the influence of the centrifuge to a position that is toward the end 114 of the test tube 110. Alternatively, blood constituents that have a lower specific gravity and are less dense can move to a position that is higher in the test tube 110 and closer to the opening 112. The more dense contents are impelled toward the outer radius of the spinning centrifuge so strongly that they displace and force aside other, less dense materials. These forces become stronger, and these processes more pronounced, as the angular velocity of the centrifuge increases. During spinning, blood constituents are free to migrate as portions of like densities congregate. The denser cells crowd to the end 114 of the test tube 110, pushing the less dense cells out of the way and forcing them to positions farther away from the end 114 of the test tube 110. The angular velocity of the centrifuge during a high-speed spinning stage can be in the general range of approximately 1500 rpm to more than approximately 3000 rpm, for example.

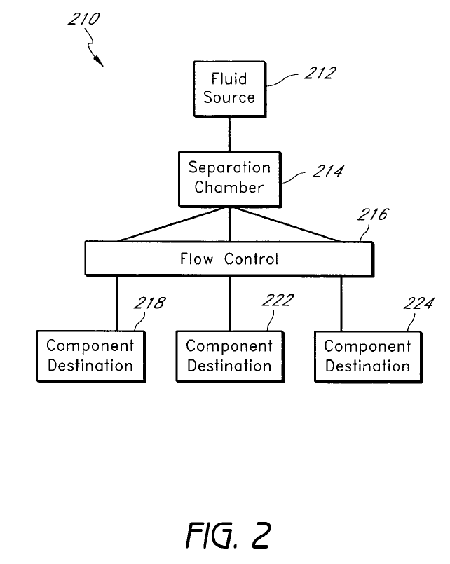

Referring to FIG. 2, a fluid source 212 can be in fluid communication with a separation chamber 214. The separation chamber 214 can be in fluid communication with a first fluid component destination 218, as well as a second fluid component destination 222 and a third fluid component destination 224. In some embodiments, some or all of the fluid component destinations can be the same as the fluid source 212. A flow control 216 is located between the separation chamber 214 and the fluid component destinations 218, 222, and 224. In this way, a continuous separation system 210 can provide for a continuing flow of fluid that is continually separated into its constituent parts. (A flow control 216 can also be located between the fluid source 212 and the separation chamber 214). In some embodiments, the flow from the fluid source 212 into the separation chamber 214 matches the flow out of the separation chamber and into the component destinations 218, 222, and 224. Thus, the net inflow to the separation chamber can be equal to the net outflow from the separation chamber. However, the relative flow rates between the component destination 218 and the other component destinations 222 and 224 need not always be equal. For example, if a particular component is not present in as high a quantity in the separation chamber as another, the flow rate for the two components can be adjusted in relation to the relative percentages of those components in the separation chamber. In some embodiments, the flow rates can be adjusted to be different from the percentage amounts of various components, thus creating a different percentage of components in the separation chambers than is present in the fluid source 212. In some embodiments, the flow control 216 can be independent for each component destination (e.g., separate flow controls for each of destinations 218, 222, and 224), which can be useful in adjusting the location of various components within the separation chamber itself. Various configurations and details of continuous separation systems are disclosed below.

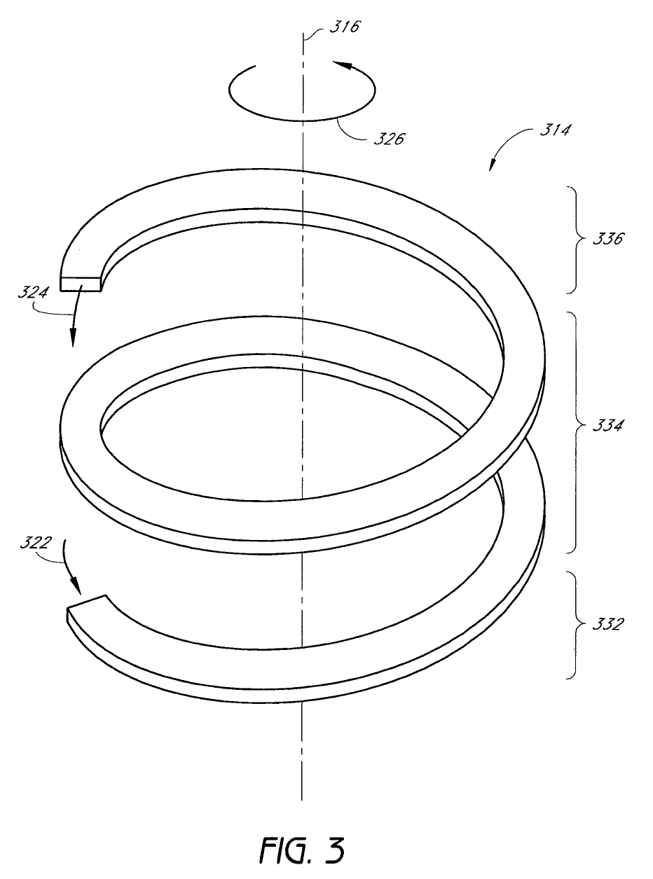

FIG. 3 schematically depicts an embodiment of a separation chamber. The spiral chamber 314 can have a generally rectangular cross-section when sliced at any point along its length. The spiral can wind around a central axis 316. If a fluid is inserted into the spiral chamber 314 in the direction indicated by the arrow 322, it can flow through the spiral chamber 314 until it comes out the other end in the direction indicated by the arrow 320. Such an upward spiral flow can be induced by an external flow controller (not shown). An external flow controller can comprise, for example, a vacuum pump, a peristaltic pump, etc. The spiral chamber 314 can be rotated around a central axis 316 as indicated by the arrow 326. Such a spinning motion can cause the fluid within the spiral chamber to separate into fluid subcomponents. Accordingly, separate fluid rings can form within the spiral chamber 314, as described further below.

In a first spiral region 332, the fluid has just recently entered the spiral chamber 314, and is more likely to not be separated into fluid subcomponents. However, as the fluid moves upwardly through the spiral chamber 314, while the spiral chamber 314 is spun rapidly about the central axis 316, the subcomponents of the fluid will be likely to separate into components of like densities, just as the components of blood can separate through centrifugation as illustrated in FIG. 1. As the components consolidate into fluid rings according to their densities, they can form separate bands of different colors within the spiral chamber 314. The higher density materials congregate towards the outer parameter of the spiral chamber 314 while the lower density components congregate towards the inner diameter of the spiral chamber 314. This process can continue, with the subcomponents separating more distinctly as the fluid moves upwardly through the spiral chamber 314, until it reaches the third spiral region 336. The overall length of the spiral chamber 314, the number and radius of turns in the spiral, the speed of rotation about the central axis 316, and the rate of flow of the fluid through the spiral chamber 314, can all have an effect on fluid separation rate and purity of subcomponents within particular fluid rings. Various other configurations of separation chambers, different from the spiral chamber 314, are also possible.

Fluid separation chambers with relatively cylindrical symmetry can be especially advantageous, because the flow of fluid through the chamber can be generally in a direction transverse to the axis of rotation. A coil or spiral fluid separation chamber configuration provides many advantages, allowing continuous, in-line separation of flowing fluid with a relatively simple geometry. Because the forces on the fluids are relatively constant along the fluid flow path, turbulence can be minimized, improving separation efficiency. When the fluid to be separated is blood drawn from a patient, higher separation efficiency can in turn help lower the total volume of blood, reducing trauma and unwanted side effects on the patient. The relatively simple geometry of such a device also allows for manufacturing efficiency. For example, a simple spiral or coil flow chamber can be a sterile, disposable portion of an apheresis system, thus reducing the time required between uses and improving safety and reducing labor costs.

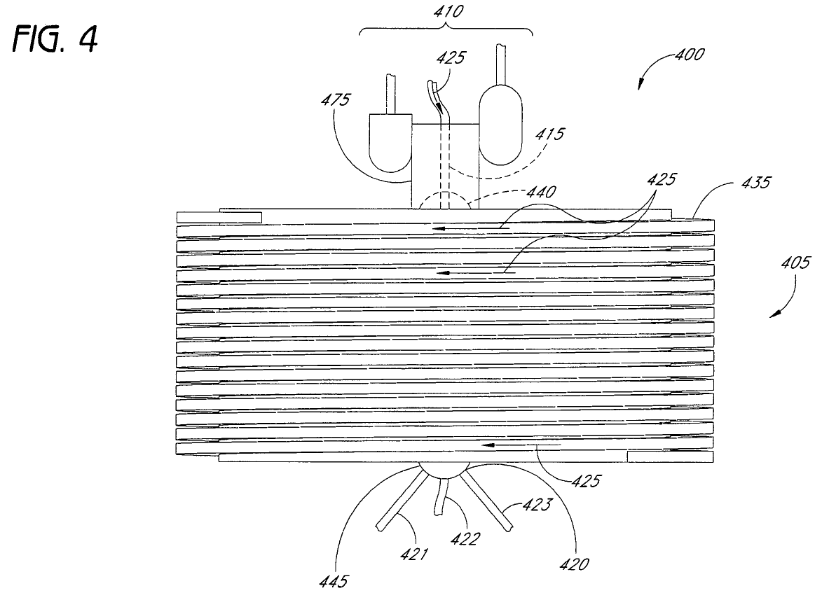

FIG. 4 shows an embodiment of a continuous centrifuge system 400 that incorporates some of the spiral flow characteristics described above with respect to FIG. 3. The continuous centrifuge system 400 includes a coil assembly 405, a pinch roller 410, an inflow conduit 415, and an outflow port 420. Arrows 425 indicate the fluid flow direction in the continuous centrifuge system 400. In particular, whole blood is directed from a patient or donor through the inflow conduit 415 to the coil assembly 405. The blood enters the coil assembly 405, which rotates about a central axis. Rotation of the blood in the coil assembly 405 causes the blood to separate into its constituents. The constituents are transferred from the coil assembly 405 to the outflow port 420, through which the constituents are directed to two or more destinations. For example, the outflow port 420 can be connected to a first outflow conduit 421, a second outflow conduit 422, and a third outflow conduit 423. Each of the outflow conduits 421, 422, and 423 are in fluid communication with a portion of the coil assembly 405. In some embodiments, the system 400 substantially separates whole blood, which can flow in through the inflow conduit 415, into blood constituents, which can flow out via the outflow conduits 421, 422, and 423.

With continued reference to FIG. 4, in some embodiments, the coil assembly 405 includes a coil 435, an inlet connector 440, and an outlet connector 445. The inlet connector 440 and the outlet connector 445 couple the inflow conduit 415 and the outflow conduits 421, 422, and 423 to the coil 435. In some embodiments, the coil 435 is rotated by the pinch roller 410 during operation of the continuous centrifuge system 400. In order to maintain the conduits 415, 421, 422, and 423 stationary, the connectors 440 and 445 are preferably revolving joints. The connectors 440 and 445 preferably are made of PTFE or of a ceramic material.

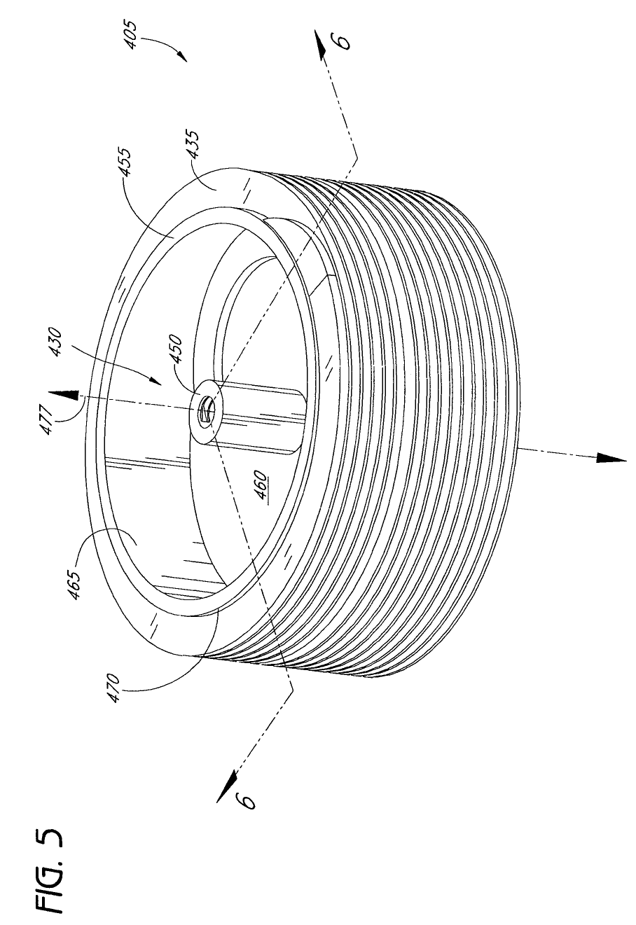

Referring to FIG. 5, an embodiment of the coil assembly 405 of FIG. 4 is illustrated in perspective view. The coil assembly 405 includes a drum 430, with a central hub 450, a rim 455, and at least one strut 460. The rim 455 includes an inner side 465 and an outer side 470. The strut 460 extends between the central hub 450 and the inner side 465 of the rim 455. In some embodiments, the central hub 450, the rim 455 and the strut 460 are all integrally made in an injection molding process. Preferably, the drum 430 is made of any suitable material, such as polyethylene, polypropylene, or polystyrene.

The drum 430 also preferably includes a sleeve 475 (FIG. 4) that is engaged by the pinch roller 410 (FIG. 4). The pinch roller 410 frictionally engages the sleeve 475 whereby rotation of the pinch roller 410 in one direction corresponds to a rotation of the drum 430 in the opposite direction. Rotation of the pinch roller 410 is thus transferred to the coil assembly 405 through the sleeve 475, whereby the coil assembly 405 rotates on an axis of rotation 477 (See FIG. 5). Rotation of the drum 430 can also be achieved in various other ways, e.g., with a motor, with gears, with a series of rollers, etc. The coil 435 is coupled with the outer side 470 of the drum 430 in one embodiment. In some embodiments, the coil 435 is sufficiently stiff such that the drum 430 is not required.

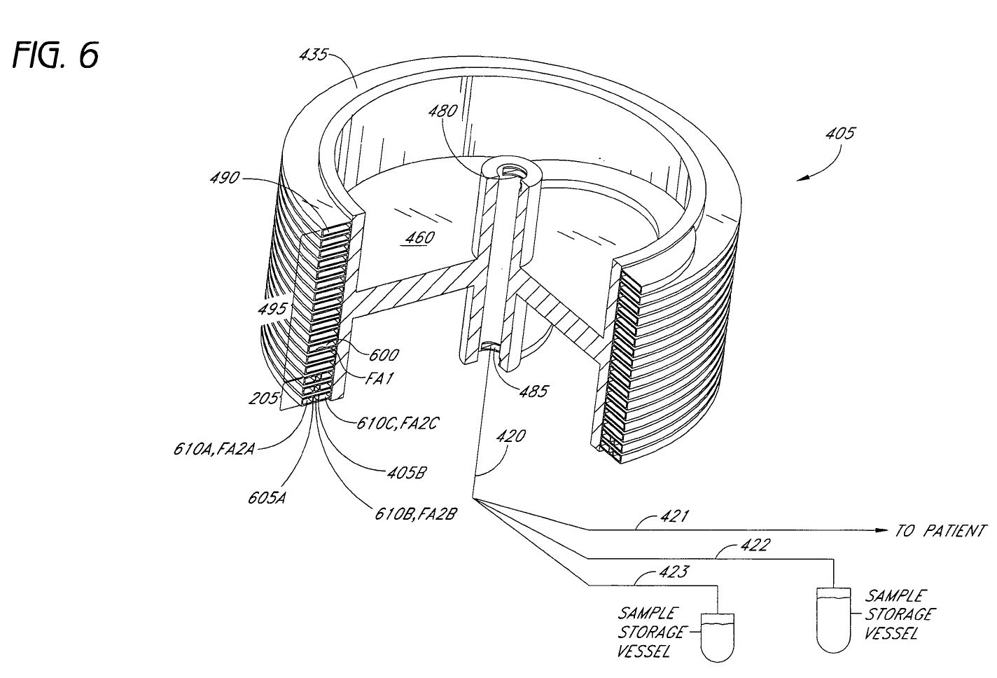

FIG. 6 shows a cutaway view of the coil assembly 405, which can include a coil inlet 480, a coil outlet 485, and a blood flow path 490 defined between the coil inlet 480 and the coil outlet 485. The coil 435 is preferably made of PTFE, an olefin, e.g., polypropylene, or any other suitable material. The blood flow path 490 has a first segment 495 that comprises a mixed flow chamber 600 and a second segment 605 that comprises three constituent chambers 610A, 610B, and 610C. While the first segment 495 is shown having one chamber 600 and the second segment 605 is shown having three chambers 610A, 610B, 610C, other numbers of chambers are possible. For example, some embodiments the first segment 495 is provided with two chambers and the second segment is provided with six chambers. In other embodiments, the first segment is provided with one chamber and the second segment is provided with two chambers.

With continued reference to FIG. 6, the length of the first segment 495 and the length of the second segment 605 can vary. As discussed above, one application of the centrifuge system 400 is the separation of whole blood into at least two constituents. Rotation of the drum 430 and coil 435 mounted thereon causes higher density constituents of the blood to migrate toward the outer wall of the chamber 600 (i.e., the wall of the chamber 600 that is farthest from the axis of rotation 477). Thus, the higher density constituents of the whole blood generally become separated from lower density constituents thereof. The tendency of a mixture of constituents with different densities to separate, or stratify, in this manner is due to the forces (e.g., centripetal or centrifugal forces) acting upon the constituents. Greater magnitude forces generally cause the blood to separate faster. Thus, under conditions generating greater forces (e.g., rotating the coil assembly 405 at relatively high rotational speeds), the length of the first segment 495 can be made shorter than under conditions generating lower forces (e.g., rotating the coil assembly 405 at relatively low rotational speeds).

While in some embodiments it is preferable to rotate the coil assembly 405 faster to cause the blood to separate faster, certain applications may call for slower rotation. For example, slower rotation of the coil assembly 405 generally provides a higher degree of separation (i.e., each of the constituents is generally purer) if the slower rotation is allowed to occur over a long enough period of time. Also, lower rotational speeds may allow less expensive materials to be used for the coil assembly 405. Thus, it may be desirable for certain applications to rotate the coil assembly 405 at a relatively low rotational speed and to select a longer first segment 495.

With continued reference to FIG. 6, the cross-sectional shape and the internal surface of the chamber 600 are configured to reduce the tendency of the flow of the blood therein to become turbulent. The cross-sectional shape of the chamber 600 is can be rectangular, providing a flow area FA1. While a rectangular cross-sectional shape is provided for the chamber 600, various other suitable cross-sections can be provided, e.g., round, oval, square, etc. Each of the chambers 610A, 610B, and 610C are formed between the inside wall of the coil 435 and at least one divider (e.g., divider 605A) located inside the coil 435 as shown. In some embodiments, a first divider 605A is provided adjacent the inside surface of the wall of the coil 435 that is closest to the axis of rotation 477 and a second divider 605B is provided between the first divider 605A and the inside surface of the wall of the coil 435 that is closest to the axis of rotation 477. In one embodiment, the location of the first divider 605A is selected or designed such that the flow area of the chamber 610A (FA2A) is sized to accommodate a flow volume corresponding to the percentage volume of red blood cells expected to be found in the whole blood. In one embodiment, the FA2A is about equal to forty-two percent of the flow area FA1. The location of the second divider 605B is selected or designed such that the flow area of the chamber 610B (FA2B) is sized to accommodate a flow amount about equal to the amount of platelets in whole blood. In some embodiments, the flow area FA2B is about eight percent of the flow area FA1. The location of the second divider 605B also is selected or designed such that the flow are of the chamber 610C (FA2C) is sized to accommodate a flow amount corresponding to the percentage volume of plasma in whole blood. In some embodiments, the flow area FA2C is about fifty percent of the flow area FA1.

As discussed above, some embodiments of the system 400 comprise the first outflow conduit 421, the second outflow conduit 422, and the third outflow conduit 423. The first outflow conduit 421 is in fluid communication with the chamber 610A, whereby red blood cells can be routed as desired, e.g., back to the patient. The second outflow conduit 422 is in fluid communication with the chamber 610B, whereby platelets can be routed as desired, e.g., to a receptacle or vessel for storage. The third outflow conduit 423 is in fluid communication with the chamber 610C, whereby plasma can be routed as desired, e.g., back to a receptacle or back to the patient.

The centrifuge system 400 is particularly advantageous in that apheresis can be performed using a relatively simple device. Apheresis is a process by which a portion of the blood (e.g., plasma, platelets, etc.) that is particularly useful for later use, such as in treatment or testing, can be separated from other constituents of blood. The constituents that are not needed for later use (e.g., the red blood cells) can be returned to the donor. The described system 405 is relatively simple, having only a few components. In addition, complex valves are generally not needed to route the whole blood and its separated constituents. Rather, in some embodiments, a single, continuous coil is provided wherein the blood flows in a continuous manner, is separated, and is routed back to the patient or into suitable receptacles for further processing. The coil assembly 405 can be produced relatively inexpensively, for example by employing mass production techniques such as injection molding.

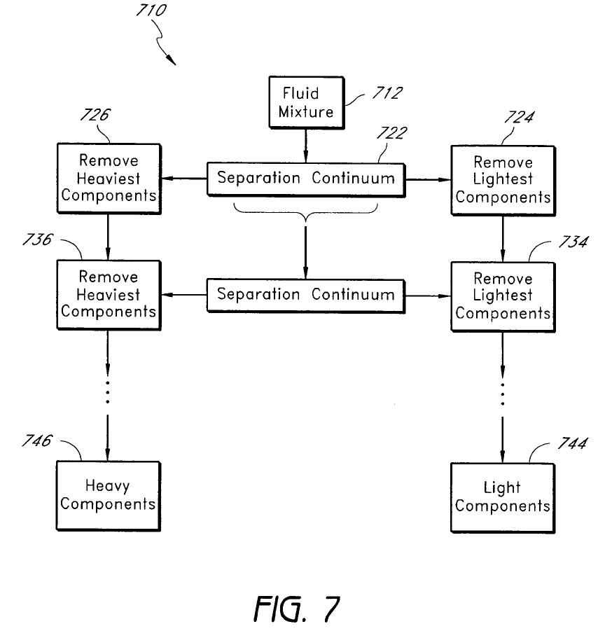

Referring to FIG. 7, a fluid mixture 712 can be positioned in fluid communication with a chamber having a separation continuum 722. The separation continuum can be induced by centrifugation, and can be a collection of fluid components having a wide variety of densities. The separation continuum can run from one portion having the heaviest components all the way through to another portion at the other end having the lightest components, and with gradually varying weights or densities in between the two extremes. In some embodiments, some of the heaviest components can be removed from one end of a chamber as shown by operational block 726. Similarly, some of the lightest components can be removed from the other end of a chamber, as shown by operational block 724. Remaining components can be moved to a second separation continuum 732 and centrifuged or otherwise separated in a similar way to that illustrated in the separation continuum 722. Likewise, the lightest components of the second separation can be removed as depicted at operational block 734 and the heaviest components can be removed as shown at operational block 736. The lightest components removed from the separation continuum 722 can be added to the same chamber of the lightest components from the separation continuum 732. Similarly, the heaviest components removed at operational block 726 can be added to the heaviest components removed at operational block 736. In this way, successive separation continua can be formed and heavy and light components can be collected into separate chambers. This process can be repeated many times until a particular result is achieved. For example, if two separate mixtures of the heavier components and the lighter components is desired, this process can achieve such a result. As shown, the heavy components can be stored in one chamber 746 while the light components are stored in another chamber 744.

In some embodiments, the lightest components removed at operational block 724 need not be added to the lightest components removed at operational block 734, and the components of operational block 726 need not be added to the components of operational block 736. In this way, components with a higher likelihood of a particular density can be extracted from the separation continuum at a desired time and/or position during the successive purification, extraction, or siphoning process. The position from which heavy or light components are extracted from the separation continuum can be chosen according to the density of the components desired. For example, in FIG. 7 the heaviest components are shown being removed from the end of the separation continuum 722 most likely to have the heaviest components, and the lightest components are shown to be removed from the opposite end of the separation continuum 722. However, if components are removed from a different portion of a separation continuum, different results and/or different densities of extracted materials can be achieved. The flow rates of extraction or siphoning can also be adjusted to change the nature of the components within the successive separation continua, or to select for a particular percentage required for use or testing. Successive fluid separation and component extraction can be adjusted in many ways to achieve various results, some of which are described further herein.

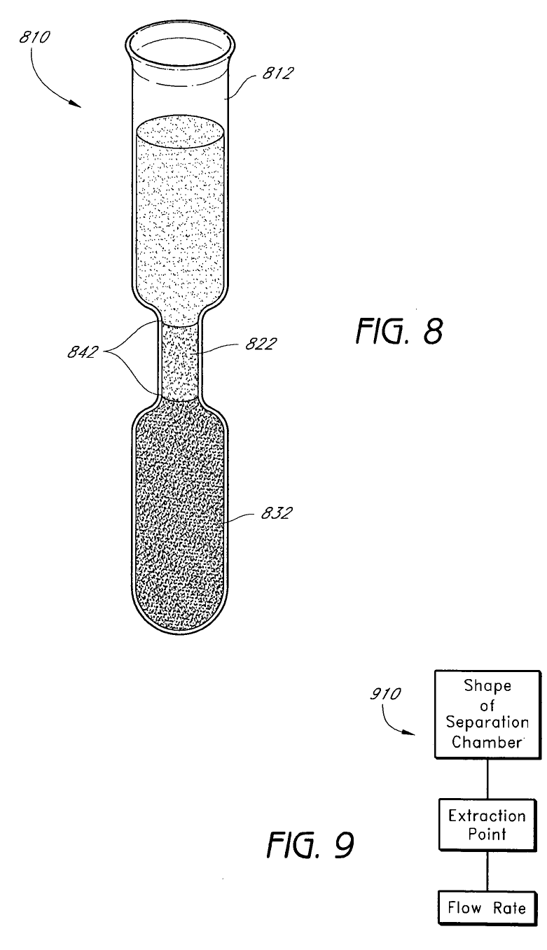

FIG. 8 illustrates one example of a configuration of a test tube-like chamber 810. An upper portion 812 of the chamber 810 can be generally similar to the upper portion of a conventional test tube (see FIG. 1). For example, if whole blood is stored in such a chamber and separated using conventional centrifuge techniques, the plasma, or less dense portion of the whole blood will tend to accumulate in the upper portion 812. The lower portion 832 will likely contain red blood cells after centrifugation of whole blood in such a chamber. Furthermore, the middle portion 822, which is shown to be narrower than the typical middle portion of a conventional test tube (see FIG. 1) can contain the “buffy coat” (see discussion of FIG. 1, above). The borders or boundaries 842 between the various fluid constituents may be less visible and/or well defined than has been depicted schematically in FIG. 8. For example, there may not be a strict demarcation indicating where the stratum of one fluid constituent ends and the stratum of another fluid constituent begins. However, in the case of blood, the different fluid subcomponents generally have different colors, so the border 842 between the various components can be optically detected. The border 842 can become more easily detected and more distinct as the fluid separation improves after the chamber has been centrifuged for a longer period of time and/or using a more efficient rotation speed, for example.

The elongate middle portion 822 can be designed such that the buffy coat will be located within the narrow neck, or middle portion 822. Such a result can be achieved if the relative proportions of the fluid to be separated are generally known and the chamber 810 is designed such that the appropriate volumes are contained within the various portions of the chamber 810. A chamber such as the chamber 810 can be especially advantageous for a continuous separation device if the continuous separation device is designed to isolate, purify, or extract components of fluid that fall within the middle portion 822. By expanding the length of the middle portion 822, the chamber 810 can allow more ready access to any materials contained within the middle portion 822. For example, if the buffy coat is contained within the middle portion 822, and a hole or passage is created through the wall of the chamber 810 into the middle 822, the hole could be positioned toward the center of the middle portion 822 and be more precisely directed at the buffy coat. In this way, extraction of buffy coat materials would be less likely to inadvertently include red blood cells from the lower portion 832 or plasma from the upper portion 812. Thus, the targeted extraction and/or purification of a buffy coat layer can be simplified and improved through configuring a chamber as shown in FIG. 8.

With reference to FIG. 9, a design process 910 is depicted schematically. In a first operational block, a shape of a separation chamber can be designed. The shape of the separation chamber can take into account the ultimate axis of rotation of the separation chamber and the desired direction of flow, as well as any technical requirements such as the size of the package into which the device must fit. The shape can also be adjusted according to the relative percentages of the fluid constituents to be separated in the chamber, as shown in FIG. 8, for example. In particular, the middle portion 822 of the chamber 810 in FIG. 8 can be positioned such that the buffy coat will be contained within it after blood has been separated in the chamber 810. Various separation chamber shapes are depicted in other figures of this application as well.

The design process 910 can also include choosing an extraction point or points. For example, fluid can be extracted from various portions of the separation chamber, according to the number and arrangement of fluid components during and after the separation process. It can be advantageous to extract fluid from a direction that is transverse to the forces that cause the fluid separation. Generally, the forces causing separation are radial. Thus, extraction can be advantageously accomplished by removing portions of the fluid from a direction that is parallel to the axis of rotation, for example, especially if the extraction is made during centrifugation.

The design process 910 can also include designing a flow rate for the various fluid extractions. If an inflow rate of the various components in a fluid mixture matches the outflow rate of the various components of a fluid mixture, the position of the separation bands will likely remain static. However, by increasing the outflow rate of one component in relation to other components, the positioning of the separation bands within the separation chamber can be changed. The order of design decisions can also be changed from that depicted in FIG. 9.

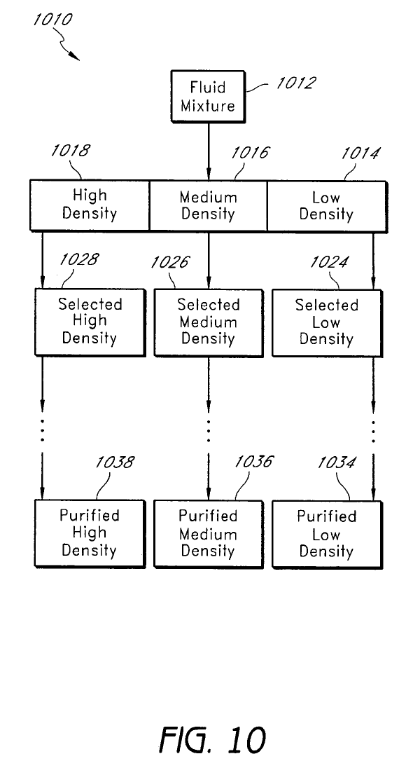

With reference to FIG. 10, a purification/separation process 1010 is depicted schematically. As shown at 1012, a fluid mixture having three components can be separated into a low density component 1014, a medium density component 1016, and a high density component 1018. The low density component 1014 can be extracted from an area that is far away from the border between the low density component and the medium density component. The selected low density component is depicted at 1024. Similarly, a selected medium density component can be taken from an area that is far from the border between low density component 1014 or the high density component 1018. Similarly, the high density component 1018 can be selected by being channeled from an area positioned away from the medium density component 1016. Thus, selected portions can be removed at selected positions. This process can be repeated to achieve greater and greater purification of the various components of the fluid mixture. The purified high density portion can be stored, as shown at 1038, separately from the purified medium density portion 1036 and the purified low density portion 1034.

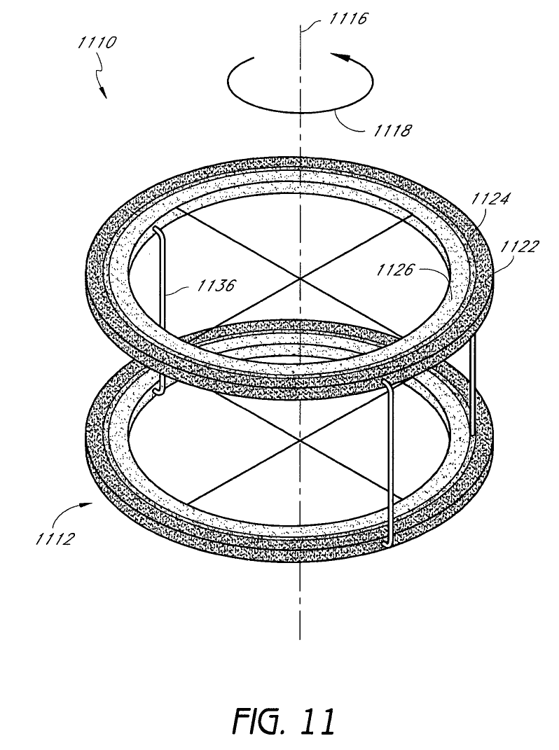

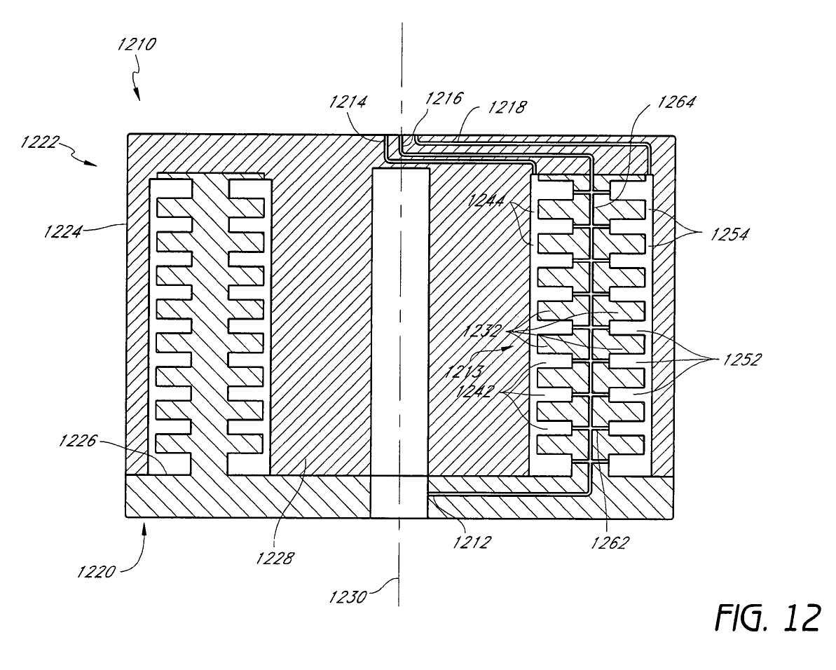

FIG. 11 schematically shows a stacked ring system 1110 that can be used for continuous fluid separation. A first ring 1112 is positioned lower than a second ring 1114, and each can be positioned around an axis 1116. The first ring 1112 and the second ring 1114 can rotate about the axis 1116 in the direction indicated by the arrow 1118, for example. The two rings can have generally rectangular cross-sections, and are depicted as having cross-sections similar to that of the spiral chamber 314 of FIG. 3. As shown in the second ring 1114, fluid present within the second ring 1114 can separate into fluid density rings that are visible as bands through the transparent wall of the second ring 1114. These bands include the inner band 1126, the middle band 1124, and the outer band 1122. If whole blood is present within the second ring 1114, for example, the inner band 1126 can comprise the plasma, the middle band 1124 may comprise the buffy coat, and the outer band 1122 may comprise the red blood cells. Such a separation into density components can be achieved by spinning the second ring 1114 about the axis 1116. If the first ring 1112 is in fluid communication with the second ring 1114, the different portions or bands inside the two rings can be in fluid communication with each other. For example, an outer tube 1132 can connect the outer band 1122 with a similar outer band in the first ring 1112. Similarly, a middle tube 1134 can connect the middle band 1124 with a similar middle band in the first ring 1112. Likewise, an inner tube 1136 can connect the inner band 1126 with a similar band in the first ring 1112. Thus, a continuous flow from the first ring 1112 to the second ring 1114 (and on to other rings, if needed) can be maintained through an external flow control whereby fluid is constantly flowing serial through the successive rings. More rings can be stacked above or below the rings depicted, and a successive ring configuration can be used for separating fluid constituents. One advantage of having successive stacked rings such as those depicted in the stacked ring system 1110 is that the placement of tubes and choice of extraction point from one ring and insertion into another ring can be carefully designed and or adjusted. For example, the outer tube 1132 is depicted as extracting fluid from the outermost portion of the first ring 1112 and inserting fluid into the outermost portion of the second ring 1114. Thus, in some embodiments, essentially only the densest components are extracted from the first ring 1112 and inserted into the second ring 1114, if the general flow of fluid is from the first ring 1112 to the second ring 1114. This choice of extraction point can assist in a purification process for a successive separation system.

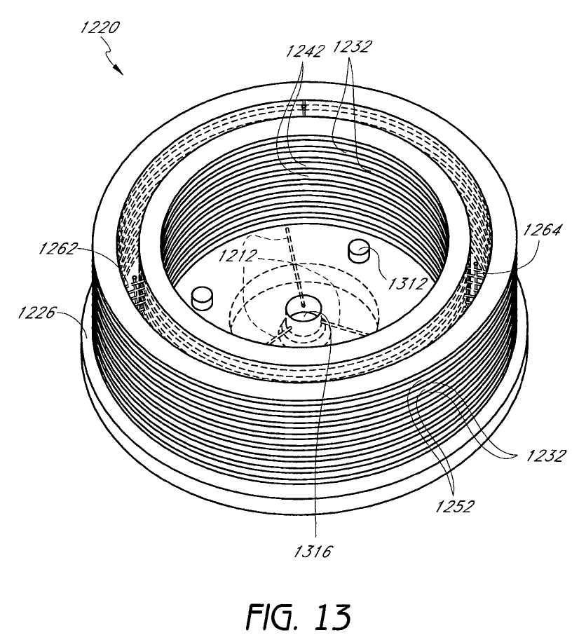

Referring to FIG. 12, a baffle embodiment 1210 is depicted schematically. A first portion 1220 can be inserted into a second portion 1222, each of which is shown in cross-section. The two portions cooperate to form a unified, but separable system. An outer sleeve 1224 extends around an outer circumference of a separation region 1213 and forms the outer wall of the separation region 1213. The outer sleeve 1224 can rest upon a seat 1226. A central hub 1228 also rests on the first portion 1220. The two-part baffle embodiment is advantageous because the intricate contours and details that will ultimately be located within another component can be accessible during manufacture for drilling, machining, etc. Likewise, for some manufacturing processes, contoured portions can be located externally in order to allow for a mold to be removed after an injection molding process, for example.

With continued reference to FIG. 12, fluid can be inserted into the device through input tube 1212. The fluid can flow through the input tube 1212 and into the separation region 1213, which includes baffles 1232. From the separation region 1213, the fluid, now separated into subcomponents, flows out of the baffle embodiment 1210 through three different extraction tubes. In particular, the low density fluid flows out through low density extraction tube 1214, the medium density fluid flows out through medium density extraction tube 1216, and high density fluid flows out through high density extraction tube 1218. Fluid separation occurs within the device as the baffle embodiment 1210 rotates about an axis 1230. The baffles 1232 are configured to allow blood to move up through the separation region 1213, becoming separated more and into more “purified” components as it moves through the system. When the fluid first arrives in the separation region 1213 through the input tube 1212, it then enters into a series of successive chambers. In particular, a series of inner chambers 1242 are located generally at an inner radius. A series of outer chambers 1252 are located generally at an outer radius. A series of thin center chambers 1262 are located at a radius in between the inner and outer radii. Each successive set of chambers located at a particular level resemble a modified test tube with a narrow and elongate central portion such as the test tube illustrated in FIG. 8. In particular, the middle portion 822 of FIG. 8 can functionally correspond to the center chamber 1262. Similarly, the upper portion 812 of FIG. 8 can functionally correspond to an inner chamber 1242, and the lower portion 832 of FIG. 8 can functionally correspond to an outer chamber 1252.

Chambers can be grouped into successive levels at different elevations (as depicted in FIG. 12) of the device. Each successive level of chambers is in fluid communication with the chambers below and above it. The flow from one level of chambers to the next is through extraction points located at positions designed to select for components that have been adequately separated. For example, an inner selection pathway 1244 has various thin passages connecting the inner chambers 1242 at the innermost radius of those chambers. In contrast, an outer selection pathway 1254 has a series of thin passages connecting the outer chambers 1252 at the outermost radius of those chambers. In some embodiments, the center chambers 1262 are likewise connected by a center selection pathway 1264 that intersects the center chambers 1262 in the center of those chambers, as far away as possible from either the outer chambers 1252 or the inner chambers 1242. In this way, fluid flowing through the separation region 1213 can become more and more separated as it moves up through the baffle embodiment 1210.

FIG. 13 shows another view of the first portion 1220 of the baffle embodiment 1210. In this illustration, the second portion 1222 that generally enclosed the separation region 1213 in FIG. 12 has been removed and the baffles 1232 are exposed. As shown, the baffles 1232 alternate with the outer chambers 1252 and with the inner chambers 1242. In some embodiments, the baffle embodiment 1210 is formed from clear plastic. Thus, in FIG. 13, the center chambers 1262 and the corresponding center selection pathway 1264 that siphons fluid from the center chambers 1262 are visible (in dashed lines) in between the inner and outer baffles 1232. Three input tubes 1212 are illustrated in the first portion 1220. FIG. 13 shows that the seat 1226 upon which the outer sleeve 1224 of the second portion 1222 rests protrudes radially outwardly beyond the baffles 1232. The disc 1312 can articulate with the second portion 1222 and can be formed integrally with the first portion 1220. Other discs 1312 are not shown in this view. As shown, a central bore 1316 can provide a passage leading to input tubes 1212, or the central bore 1316 can allow for insertion of a rod (not shown) about which the baffle embodiment 1210 can rotate. The first portion 1220 of the baffle embodiment 1210 can comprise or be connected to a rotating connection that allows an external source tube (not shown) to be in fluid communication with the input tube 1212. Such a rotating connection can have the characteristics described with respect to the inlet connector 440 of FIG. 4.

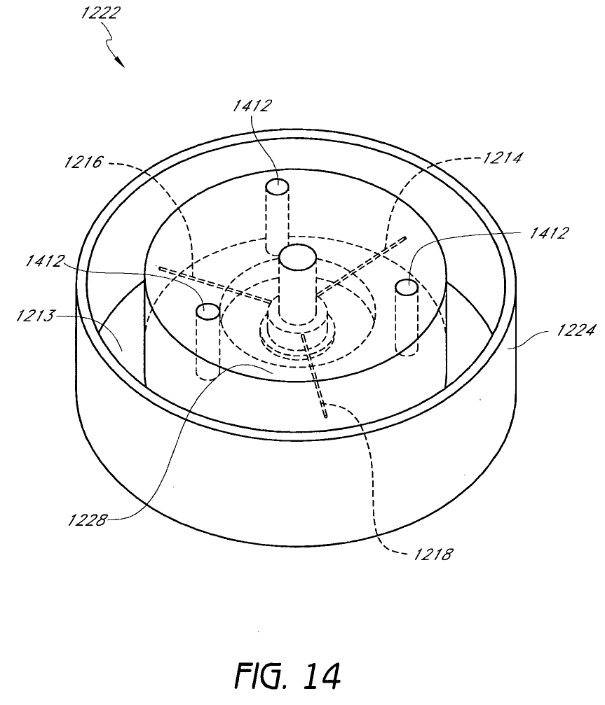

FIG. 14 shows another view of the second portion 1222 of the baffle embodiment 1210. The first portion 1220 that was inserted into the separation region 1213 in FIG. 12 has been removed and the second portion 1222 has been turned over to illustrate its structure. The sleeve 1224 and the hub 1228 are illustrated in this orientation. Three output tubes 1214, 1216, and 1218 are shown in dashed lines. The hub 1228 also has several bores, including a central bore 1317 that can correspond to the central bore 1316 of FIG. 13, and three side bores 1412 that can cooperate with the protrusions 1312 in the first portion 1220 of the baffle embodiment 1210. The second portion 1222 of the baffle embodiment 1210 can comprise or be connected to a rotating connection that allows external drain tubes (not shown) to be in fluid communication with the output tubes 1214, 1216, and 1218. Such a rotating connection can have the characteristics described with respect to the outlet connector 445 of FIG. 4.

Various materials can be used to form the separation chambers described herein, including materials that are approved by government agencies. For example, various polyolephins, such as high density polyethylene and polypropylene can be used.

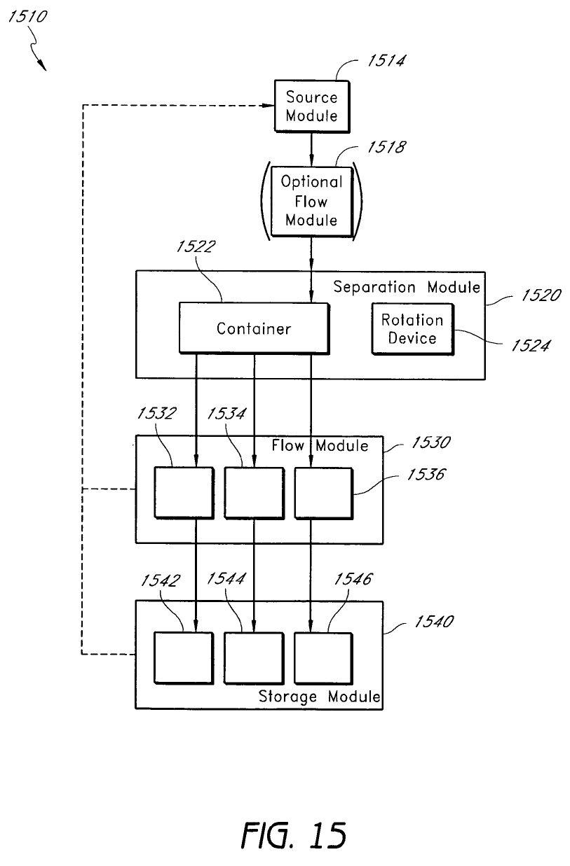

FIG. 15 shows a system 1510 for separating fluid in a continuous flow device. A source module 1514 (e.g., a container of mixed fluid, a human patient, etc.) provides the fluid to be separated (e.g., blood). An optional flow module 1518 (e.g., a peristaltic pump) can motivate and/or control the flow of fluid from the source module 1514 to the separation module 1520. The flow module 1518 can comprise any suitable fluid pump. One advantageous embodiment employs a peristaltic pump that urges fluid through the system, generally without any need for valves. This can allow the fluid to remain isolated in a generally sterile environment inside a tube, for example. The separation module 1520 can comprise a container 1522 (e.g., a separation chamber such as the baffle embodiment 1210, the coil assembly 405, etc.) that is rotated by a rotation device 1524 (such as an electric motor). Separated fluid can flow from the separation module 1520 into a storage module 1540 or back into the source module 1514. The flow of the separated fluid components can be controlled independently by flow controllers 1532, 1534, and 1536 (e.g., peristaltic pumps). In some embodiments, the storage module 1540 contains separate storage chambers 1542, 1544, and 1546 (e.g., plastic bottles, blood bags, integral chambers, reservoirs, etc.)

Fluid can flow through a system 1510 through a fluid path that can be any continuous tube or pathway. For example, ANSI standard medical tubing of various widths can be used. One specific example is TYGON® tubing. Blood, for example, can flow from the patient's arteries or veins into the tubing through medical needles. The tubing diameter can be chosen to provide a desired fluid flow rate. Furthermore, the length of the fluid path can be adjusted according to various parameters. Advantageous embodiments provide a short fluid path after the fluid exits the fluid control system and before the fluid reenters the patient. This can minimize unwanted temperature change and/or contamination of the fluid. In some embodiments, a shorter overall length of fluid path is provided to minimize the amount of fluid required to fill the system. This can minimize adverse health consequences of removing too much blood from the body, such as brain stem collapse, organ atrophy, tissue necrosis, organ failure, oxygen debt, and shock, for example. A shorter fluid path can also allow for lower flow rates, minimizing the volume of blood outside the body. The fluid path can be configured to optimize the path length inside a fluid separation device, while minimizing the path length between the device and the body. This configuration can provide higher portability and system efficiency, for example.

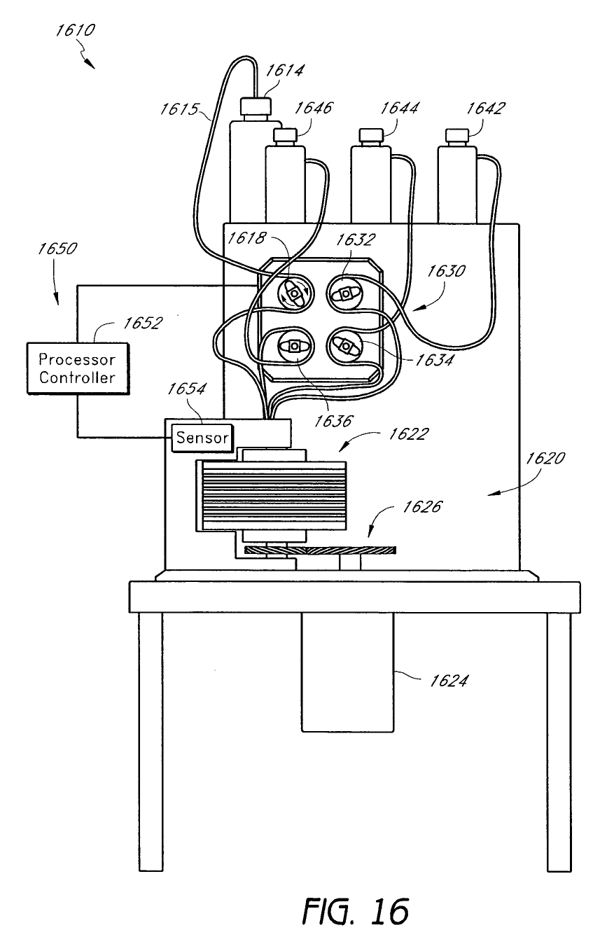

FIG. 16 shows an exemplary embodiment of a system 1510. Many other configurations are also possible, including those that include many of the same functional elements but have been engineered to fit within a smaller (e.g., portable or modular) package and optimized for commercial mass production. In particular, the portions of the device that contact fluid can be designed as a separate disposable component of a system 1510, while the rotation and flow control mechanisms can be more permanent.

FIG. 16 schematically depicts a testing system 1610. A source bottle 1614 provides fluid through a source hose 1615 that is threaded through a source pump 1618 that is depicted as a peristaltic pump. A peristaltic pump can be used to urge fluid to flow through hose 1615. As illustrated, a peristaltic pump can have two rollers. As the peristaltic pump 1618 turns, as indicated by the arrows, the rollers contact the hose 1615. As the rollers depress the sidewalls of the hose 1615 and roll along the hose 1615, fluid contained within the hose is urged to flow in a direction complimentary to the movement of the rollers. The rollers can partially or completely compress the hose, depending on the hose's thickness, the size of the rollers, etc. Movement of fluid through the hose in turn causes fluid to flow throughout the length of the hose 1615 and indeed through the rest of the system 1610. Because the fluid within hose 1615 is contained within a continuous fluid system, movement of fluid in one part of the hose 1615 causes movement of fluid throughout the entire length of the fluid pathway. The peristaltic pump 1618 can be driven by a motor (not shown).

With continued reference to FIG. 16, the source fluid flows from the hose 1615 into a separation module 1620 comprising a rotating separation chamber 1622 that is rotated (through a connection provided by gears 1626) with a motor 1624. After the fluid has been separated, three fluid components flow out of the separation module 1620 in three separate tubes to the flow module 1630, which comprises three independent outflow pumps 1632, 1634, and 1636. The outflow pumps 1632, 1634, and 1636 can be peristaltic pumps that operate similarly to the source pump 1618, and can even be contained within the same pumping device, as shown. The separated fluid components then flow to three independent storage bottles 1642, 1644, and 1646.

With continued reference to FIG. 16, an optical control system 1650 can provide feedback control to the peristaltic pumps. For example, a sensor 1654 can detect the relative sizes and/or positions of the bands of separated fluid within the separation chamber 1622. The position and size of the fluid bands can be adjusted such that the extraction points are aligned with the correct fluid band, as discussed above. Adjustments can be made by speeding up or slowing down the speed of the pumps, which can be independently controlled. Preferably, the flow rate of fluid into the separation chamber 1622 matches the flow rate of fluid out of the separation chamber 1622. The sensor 1654 can comprise, for example, a CCD digital system, a color sensor, an LED or laser device, a CMOS imaging sensor, or any other general imaging sensor or device. The sensor 1654 can shine a light that reflects from the separated fluids and is detected by a photodiode, for example. In some embodiments, light can pass through fluid layers and back-lighting the layers to improve the sensor's capabilities. Various other sensor configurations are possible. The sensor can feed electrical signals to a processor/controller 1652, which can process the signals and determine (e.g., with input from an operator) how to adjust the pumping speeds. The processor/controller 1652 can include edge-detection algorithms that analyze the signals from the sensor 1654 and detect a boundary or boundaries between fluid bands.

Although the present inventions have been described in terms of certain preferred embodiments, other embodiments apparent to those of ordinary skill in the art also are within the scope of this invention. Thus, various changes and modifications may be made without departing from the spirit and scope of the inventions. Moreover, not all of the features, aspects and advantages are necessarily required to practice the present inventions. Accordingly, the scope of the present inventions is intended to be defined only by the claims that follow.

We claim:

1. A continuous fluid separation system comprising:
a fluid source comprising fluid with at least two fluid subcomponents;
at least one fluid pump;
a rotating device;
a separation chamber having an axis of rotation through which bulk fluid moves in a direction transverse to the axis of rotation.

2. The fluid separation system of claim 1, wherein the separation chamber is in a spiral configuration with a rectangular cross-section.

3. The fluid separation system of claim 1, wherein the separation chamber comprises baffles and fluid extraction channels.

4. The fluid separation system of claim 3, wherein the fluid extraction channels are parallel to the axis of rotation.

5. An apparatus for fluid separation comprising:
a fluid separation chamber comprising:
a first portion having a first width and a first fluid extraction point located apart from the second portion;
a third portion having a third width and a third fluid extraction point located apart from the second portion;
a second portion between the first and third portions with a second width that is narrower than the first and third widths and a second fluid extraction point that is located apart from the first and third portions;
three fluid extraction pathways in fluid communication with the first, second, and third fluid extraction points.

6. A method for designing a continuous fluid separation system comprising:
choosing a shape of a separation chamber;
choosing extraction points for fluid components;
choosing a flow rate for fluid components.

7. A continuous centrifuge system, comprising:
a drum;
a coil comprising a coil inlet, a coil outlet, and a blood flow path defined therebetween, the blood flow path comprising a first segment that comprises at least one mixed-fluid chamber and a second segment that comprises at least two constituent chambers, the coil being coupled with a surface of the drum;
an inlet connector configured to transfer whole blood from a source conduit to the inlet of the coil;
an outlet connector configured to transfer blood constituents from each of the constituent chambers of the second segment of the blood flow path to corresponding outlet conduits;
whereby rotation of the drum causes whole blood transferred to the coil inlet to be substantially separated into at least two blood constituents at the coil outlet.

8. The continuous centrifuge system of claim 1, wherein the second segment of the coil comprises three constituent chambers.

9. The continuous centrifuge system of claim 1, wherein the first segment of the coil comprises one mixed-flow chamber.

10. The continuous centrifuge system of claim 3, wherein the second segment of the coil comprises three constituent chambers.

11. The continuous centrifuge system of claim 1, wherein the coil is connected to an outer surface of the drum.

12. The continuous centrifuge system of claim 1, wherein the drum further comprises a central hub, an outer rim, and at least one strut extending between the central hub and the outer rim.

13. A continuous blood separator, comprising:
a coil having an inlet, an outlet, and a blood flow path defined therebetween, the blood flow path comprising a first segment having at least one whole blood passage and a second segment having at least two blood constituent passages, the inlet configured to receive whole blood and to direct the whole blood to the first segment of the blood flow path, the outlet configured to receive at least one blood constituent from each of the blood constituent passages;
wherein the first segment is dimensioned such that the whole blood received at the inlet of the coil is substantially separated into blood constituents therein.

14. The blood separating apparatus of claim 7, wherein a length is defined between the inlet the second segment whereby the whole blood received at the inlet of the coil is substantially separated into blood constituents.

15. A method of continuously separating fluid into constituents comprising:
providing a fluid mixture;
rotating the fluid mixture in a first separation chamber to separate the fluid into constituents inside the first separation chamber, each constituent having a boundary region where that fluid constituent borders on another fluid constituent;
separately siphoning the fluid constituents from the separation chamber through openings formed apart from the boundary regions.

16. The method of claim 15, further comprising rotating the siphoned fluid constituents in a second separation chamber and separately siphoning the fluid constituents from the second separation chamber through openings formed apart from the boundary regions in the second separation chamber.

17. A fluid separation device comprising:
a first portion having an input tube and baffles;
a second portion having an outer sleeve, a hub, and output tubes; and
a separation region formed between the first and second portions comprising successive inner and outer chambers that are in fluid communication with each other and with the input tube and the output tubes.

18. A continuous flow centrifugation system comprising:
a source module comprising mixed fluid;
a flow module;
a rotating separation module comprising inner chambers with a smaller radius, and outer chambers with a larger radius; and
extraction channels in fluid communication with the inner and outer chambers.

19. The system of claim 18, further comprising fluid pathways connecting the extraction channels to storage modules.

20. The system of claim 18, further comprising fluid pathways connecting the extraction channels to the source module.

21. The system of claim 18, wherein the source module comprises a human.

22. The system of claim 18, wherein the flow module comprises a peristaltic pump.

23. The system of claim 18, wherein the separation module comprises baffles.
